(19) United States
(12) Patent Application Publication
(10) Pub. No.: US 2004/0189979 A1
(43) Pub. Date: Sep. 30, 2004

(54) Multipoint measurement system and method

(76) Inventors: Shinji Fujimura, Ritto-shi (JP); Tatsuya Harina, Kyoto-shi (JP); Kunikazu Taguchi, Hirakata-shi (JP)

Correspondence Address: FINNEGAN, HENDERSON, FARABOW, GARRETT & DUNNER, LLP, 1300 I STREET, NW, WASHINGTON, DC, 20005, US

(21) Appl. No.: 10/486,584

(22) PCT Filed: Mar. 24, 2003
(86) PCT No.: PCT/JP03/03497

(30) Foreign Application Priority Data
Mar. 29, 2002 (JP) 2002-095671

(51) Int. Cl. G01N 21/00; G01N 21/55; G01N 21/47

(52) U.S. Cl. 356/73; 356/443; 356/445; 356/446

(57) ABSTRACT

There is presented a multipoint measurement system comprising light sources (1, 2); a plurality of illuminating fibers (5, 6) for transmitting light from the light sources to a sample so as to illuminate a plurality of points of the sample (A, B); a plurality of receiving fibers (8, 9) for collecting light beams including transmitted, reflected, scattered light beams at the plurality of points; a beam selector (10) which comprises a rotatable disk (12) having an aperture for transmitting a light beam collected by one of the plurality of receiving fibers (8, 9) through the receiving fiber (11); and an MCPD (4). When the rotatable disk (12) is rotated so that the aperture is displaced to and stops at a position at which light at the desired channel passes through, it is possible to perform measurement only on the light passing through the corresponding receiving fiber (8, 9, 11). Light at any other channel may be measured by rotating the rotatable disk (12) by a predetermined angle.

### MULTIPOINT MEASUREMENT SYSTEM AND METHOD

### TECHNICAL FIELD

The present invention relates to a multipoint measurement system and a multipoint measurement method capable of performing optical measurements on samples such as films, glass, magneto-optical (MO) disks to measure optical transmittance, optical reflectance, scattered light intensity at a plurality of points.

### PRIOR ART

Various samples are evaluated and tested by measuring the optical properties thereof such as light transmittance, optical reflectance, scattered light intensity.

Depending on the sample, there are times when such optical measurements should preferably be performed at a plurality of points so as to improve the reliability of the evaluation and testing results.

Where such multipoint measurements are performed on sample, increasing the speed of measurement is required. For this reason, a multichannel simultaneous measurement needs to be performed.

Accordingly, in order to perform multipoint measurements on samples, it has been conventionally required that two or more optical measuring instruments such as spectrophotometers be prepared according to the number of the measuring points, or that an optical measuring instrument capable of performing multichannel simultaneous measurement be prepared.

When equipped with a plurality of optical measuring instruments, the measuring system becomes heavy and large, and the cost is also increased.

Although it will be convenient if an optical measuring instrument capable of performing multichannel simultaneous measurement can be used, because of the problem inherent in such measuring instruments that it is hard to maintain separation among the channels when a highly sensitive measurement dealing with weak light beams is performed, generally, it has been difficult to adopt such optical instruments.

Accordingly, it is a primary object of the present invention to provide a multipoint measurement system and a multipoint measurement method capable of performing multipoint simultaneous measurements, in which there is provided an optical measuring instrument comprising one instrumentation channel and multipoint simultaneous measurement is accomplished by the selection of optical path.

### DISCLOSURE OF THE INVENTION

A multipoint measurement system according to the present invention comprises: a light source, a plurality of illuminating fibers for transmitting light from the light source to a sample so as to illuminate a plurality of points of the sample, a plurality of receiving fibers for collecting light beams including transmitted, reflected, and scattered light beams at the plurality of points, an optical path selecting member for transmitting a light beam collected by one of the plurality of receiving fibers through the receiving fiber, and an optical measuring instrument. (claim 1)

According to the above structure, the optical path selecting member permits free selection of any desired optical channel. By sequentially changing the optical channel to be measured, measurements of the sample at the plurality of points can be performed almost simultaneously.

It is also possible to adopt a structure wherein the plurality of receiving fibers are divided into first receiving fibers and second receiving fibers and arranged along a circumference, and the optical path selecting member comprises a rotatable disk which has an aperture for passing light and is provided between the first receiving fibers and second receiving fibers. (claim 2). By rotating the rotatable disk so that the aperture is displaced to and stops at the position of a receiving fiber that transmits light at the channel desired for a measurement, only the specific receiving fiber is allowed to pass the light, thereby the measurement can be carried out. When light at any other channel is measured, the measurement can be accomplished by rotating the rotatable disk by a predetermined angle.

As described above, the selection of an optical channel desired for a measurement can be accomplished by a simple structure in which the receiving fibers are divided and a rotatable disk is provided. Measurements of the sample at a plurality of points can be accomplished almost simultaneously by one turn of the rotatable disk.

In addition, the optical path selecting member may comprise drivable shutters provided between the first receiving fibers and the second receiving fibers. (claim 3) In this case, the receiving fibers do not need to be arranged along a circumference.

The selection of an optical channel desired for a measurement can be accomplished by opening one of the shutters. Measurements of the sample at a plurality of positions can be accomplished almost simultaneously by shifting the optical channel to be measured.

A multipoint measurement method according to the present invention is a multipoint measurement method for performing optical measurements by transmitting light of a light source through, a plurality of illuminating fibers to a sample so as to illuminate a plurality of points of the sample, collecting light of the light source and light beams including transmitted, reflected, scattered light beams at the plurality of points by a plurality of receiving fibers, and supplying the collected light beams to an optical measuring instrument, the multipoint measurement method comprising the steps of: a process for performing a base measurement for measuring light that is transmitted through the illuminating fibers and receiving fibers in a condition where there is no influence of a sample and performing a first monitoring of light of the light source; a process for performing a sample measurement carried out with a sample being placed for measuring light transmitted through the illuminating fibers, the sample, and the receiving fibers and performing a second monitoring of light of the light source; a process for obtaining an optical measurement value of the sample by dividing the quotient of an optical intensity obtained from the sample measurement with the sample being placed/an optical intensity of the light source obtained from the second monitoring by the quotient of an optical intensity obtained from the base measurement with no influence of a sample/an optical intensity of the light source obtained from the first monitoring; and a process for outputting the obtained optical measurement value of the sample. (claim 4)

By this method, the quotient of an optical intensity obtained from the sample measurement with the sample being placed/an optical intensity of the light source obtained from the second monitoring is divided by the quotient of an optical intensity obtained from the base measurement with no influence of a sample/an optical intensity of the light source obtained from the first monitoring. As a result, it is possible to obtain an optical measurement value of the sample where scattering of the optical measurement conditions associated with the structure of the measurement system and temporal variation in optical intensity of the light source have been corrected. Accordingly, the measuring accuracy can be improved.

A multipoint measurement method according to the present invention is a multipoint measurement method using the aforesaid multipoint measurement system, the multipoint measurement method comprising the steps of: a process for performing a base measurement for measuring light that is transmitted through the illuminating fibers and receiving fibers in a condition where there is no influence of a sample and performing a first monitoring of light of the light source; a process for performing a sample measurement carried out with a sample being placed for measuring light transmitted through the illuminating fibers, the sample, and the receiving fibers and performing a second monitoring of light of the light source; a process for obtaining an optical measurement value of the sample by dividing the quotient of an optical intensity obtained from the sample measurement with the sample being placed/an optical intensity of the light source obtained from the second monitoring by the quotient of an optical intensity obtained from the base measurement with no influence of a sample/an optical intensity of the light source obtained from the first monitoring; and a process for outputting the obtained optical measurement value of the sample. (claim 5)

By this method, by the use of the aforementioned multipoint measurement system, the quotient of an optical intensity obtained from the sample measurement with the sample being placed/an optical intensity of the light source obtained from the second monitoring is divided by the quotient of an optical intensity obtained from the base measurement with no influence of a sample/an optical intensity of the light source obtained from the first monitoring. As a result, it is possible to obtain an optical measurement value of the sample where scattering of the optical measurement conditions associated with the structure of the measurement system and temporal variation in optical intensity of the light source have been corrected. Accordingly, the measuring accuracy can be improved.

### BRIEF DESCRIPTION OF THE DRAWINGS

FIG.1 is a block diagram illustrating a thin-film vapor deposition monitoring system as one embodiment of the present invention.

FIG. 2 is a structural view illustrating an MCPD and other sections on the output side thereof.

FIG. 3 is a perspective view showing the structure of a beam selector 10.

FIG. 4 illustrates the structure of a beam selector in which shutters 16a-16h that are drivable by solenoids S1-S8 are disposed between first receiving fibers and second receiving fibers.

### EMBODIMENTS OF THE INVENTION

The present invention is now described referring to the appended drawings.

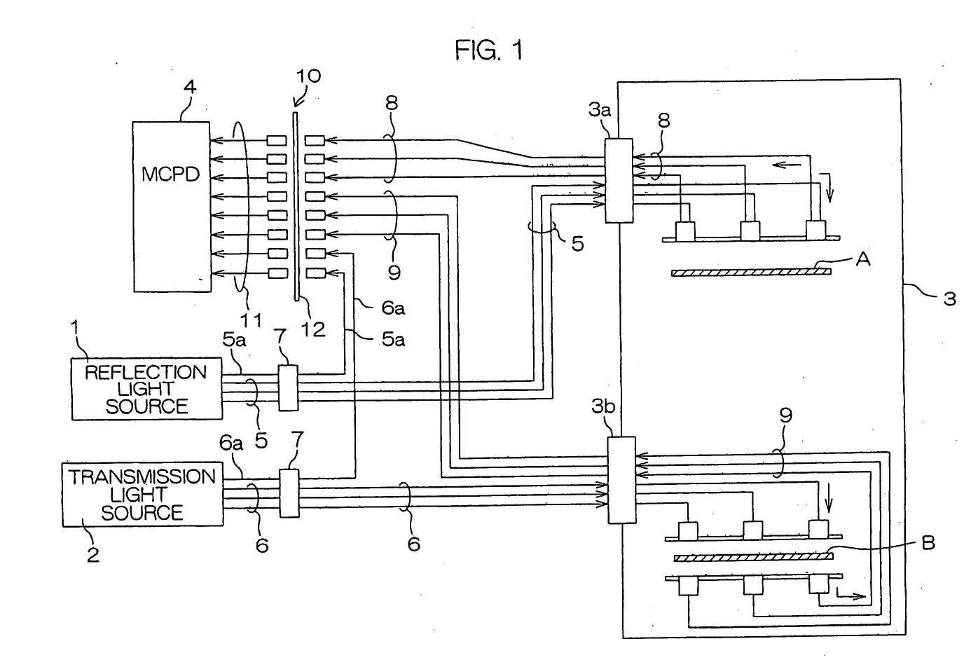

FIG.1 is a block diagram illustrating a thin-film vacuum deposition monitoring system as one embodiment of the multipoint measurement system according to the present invention.

The measurement system comprises a reflection light source 1 (such as an Xe lamp) for measuring light reflected from a sample, a transmission light source 2 (such as an I₂ lamp) for measuring light transmitted through the sample, a vacuum chamber 3 for fabricating sample films, and a multichannel spectrophotometer (MCPD) 4.

Three illuminating fibers 5, 6 and one receiving fiber 5a, 6a are connected to each light source 1, 2, respectively.

Binders 7 bundles the fibers together. The illuminating fibers 5 are introduced into the vacuum chamber 3 through a vacuum flange 3a, and the illuminating fibers 6 are introduced into the vacuum chamber 3 through a vacuum flange 3b. Vapor-deposited films A and B are each set on two sample holders (not shown) disposed inside the vacuum chamber 3.

Measurements of light reflected from the film A are performed at the upper sample holder. Three light receiving fibers 8 that collect reflected light beams are provided, which form three couples with the three illuminating fibers 5 extending from the reflection light source 1. The three light receiving fibers 8 that collect reflected light beams exit from the vacuum chamber 3 through the vacuum flange 3a and are connected to the beam selector 10.

Measurements of transmitted light from the film B are performed at the lower sample holder. The three illuminating fibers 6 extending from the transmission light source 2 each illuminate from above a different portion of the film B. Three light receiving fibers 9 that collect transmitted light beams are disposed below the film B. The three light receiving fibers 9 exit from the vacuum chamber 3 through the vacuum flange 3b and are connected to a beam selector 10.

The receiving fiber 5a connected to the reflection light source 1 and the receiving fiber 6a connected to the transmission light source 2 are provided for measuring the optical intensities of the light sources, and introduced directly into the beam selector 10.

Eight second receiving fibers 11 are provided on the output side of the beam selector 10, each of which is inputted into the MCPD 4. Meanwhile, the aforesaid receiving fibers 8, 9, receiving fiber 5a, receiving fiber 6a constitute “first receiving fibers”.

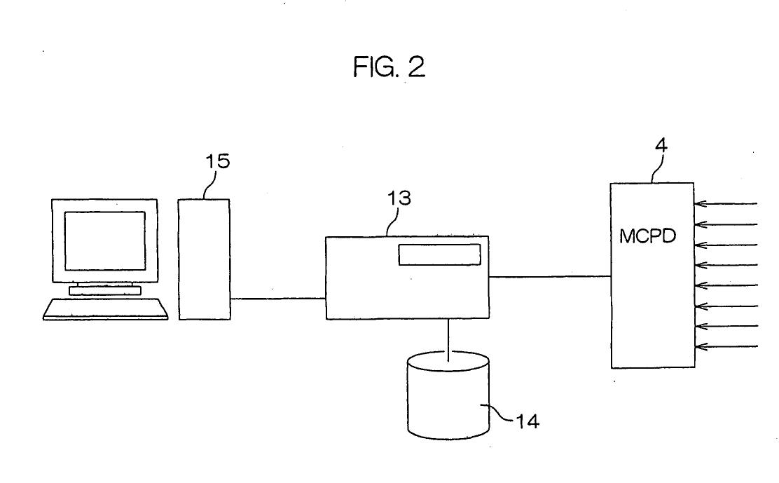

FIG. 2 is a structural view illustrating an MCPD and other sections on the output side thereof. Multichannel output signals of the MCPD4 are each supplied to a computer 13. At the computer 13, the eight output signals are processed by calculation to give various values such as reflected light intensity, transmitted light intensity, spectrum configuration, tristimulous values at each point of the sample films. Then, digital signals indicative of the measured values are generated and written to a magneto-optical disk 14, and supplied to a computer 15 at the same time.

The microcomputer 15 performs processing such as processing the signals to form graphs based upon the various measured values and make them displayed on a display.

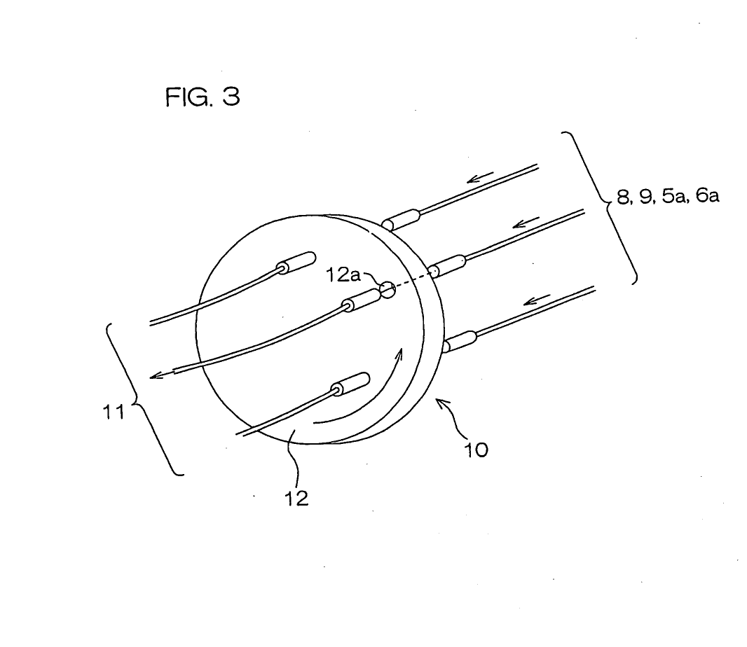

FIG. 3 is a perspective view showing the configuration of a beam selector 10. The beam selector 10 comprises the first receiving fibers, 8, 9, 5a and 6a, the second receiving fibers 11, and a rotatable disk 12 having an aperture 12a therein. The rotatable disk 12 is rotationally driven by a motor or the like that is not diagramed. In FIG. 3, while three first receiving fibers and three second receiving fibers are illustrated, in this example, they are each eight in number, and there are eight couples.

The couples of first receiving fibers and second receiving fibers are provided being optically aligned with each other so as to readily pass light.

There is only one aperture 12a provided in the rotatable disk 12 so that, as the rotatable disk rotates, the couples of first receiving fibers and second receiving fibers are caused to transmit light by the aperture 12a one by one. Each of the eight couples of the optical fibers are caused to transmit light during one turn of the rotatable disk 12.

A series of processes for measuring the light transmitted through a film and the light reflected therefrom by the use of the thin-film vacuum deposition monitoring system will be described below.

(1) Base measurement This base measurement is carried out every day on a regular basis before the line is run in a factory. Transmitted light is measured in a condition without a sample film or with a transparent base film being placed, and reflected light is measured with a mirror or a transparent base film having an intensity reflectance of about 1 being placed. The points of measurement are, as described above, three points for transmitted light intensity, one point for monitored optical intensity of the transmitting light source, three points for reflected light intensity, and one point for monitored optical intensity of the reflecting light source.

Measured values of the transmitted light intensity are represented by T₁(0), T₂(0), and T₃(0), measured values of the reflected light intensity are represented by R₁(0), R₂(0), and R₃(0), and monitored optical intensities of the transmitting light source and reflecting light source are represented by TM(0) and RM(0), respectively. The subscripts 1, 2, 3 indicate the points of measurement, and the number 0 in the parentheses indicates base measurement. A subscript “i” is used to represent the points of measurement (i =1, 2, 3).

The following correction factors for correcting scattering of the optical measurement conditions associated with the structure of the thin-film vapor deposition monitoring system are determined.

Tᵢ (0)/TM(0)

Rᵢ (0)/RM(0)

(2) Sample measurement Transmitted light and reflected light are measured with sample films being placed. The points of measurement are three points for transmitted light intensity, one point for monitored optical intensity of the transmitting light source, three points for reflected light intensity, and one point for monitored optical intensity of the reflecting light source.

Measured values of the transmitted light intensity are represented by T₁, (k), T₂(k), and T₃(k), measured values of the reflected light intensity are represented by R₁, (k), R₂(k), and R₃(k), and monitored values of the optical intensities of the transmitting light source and reflecting light source are represented by TM(k) and RM(k), respectively. The numeral “k” (k=1, 2, 3) in the parentheses indicates sample number.

The following optical intensities of the sample where temporal variation in optical intensity of the light sources is corrected are determined.

Tᵢ(k)/TM(k)

Rᵢ(k)/RM(k)

(3) Correction As shown below, by dividing the optical intensities of the sample obtained in the sample measurement where temporal variation in optical intensity of the light sources is corrected by the correction factors that are obtained in the base measurement, it is possible to obtain values of the optical intensity of the sample where scattering of the optical measurement conditions associated with the structure of the thin-film vapor deposition monitoring system and temporal variation in optical intensity of the light sources have been corrected.

Intensity of light transmitted through the sample

=Tᵢ(k) TM(0)/TM(k)Tᵢ(0)

Intensity of light reflected from the sample

=Rᵢ(k) RM(0)/RM(k)Rᵢ(0)

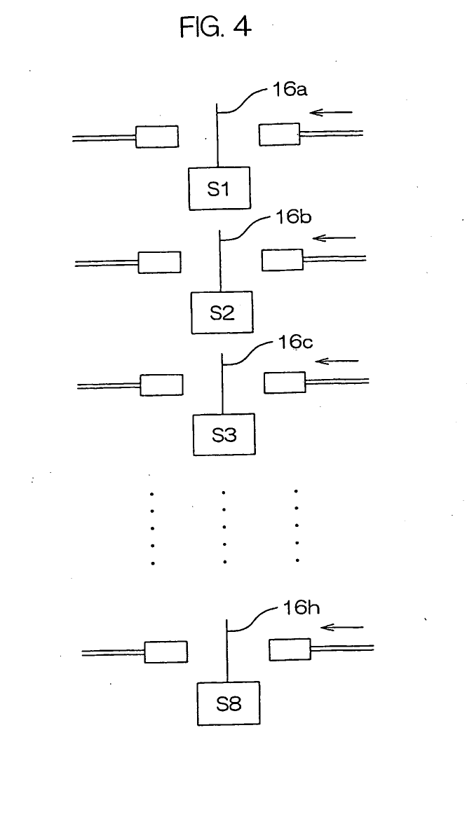

An embodiment of the present invention has been heretofore described. However, the forgoing embodiment should not be construed as limiting the scope of the invention. For example, instead of the use of a rotatable disk, the beam selector may be arranged in other ways including the case shown in FIG. 4 in which shutters 16a-16h that are drivable by solenoids S1-S8 are disposed between first receiving fibers and second receiving fibers. By opening any one of these shutters, light passes through only the opening at which the shutter is opened. The light at the corresponding channel can thus be measured. It is possible to sequentially select a channel by opening the shutters one by one in the same manner as where the rotatable disk is rotated.

Also, if the multichannel spectrophotometer (MCPD) in the multipoint measurement system is of a kind capable of simultaneously measuring light at a plurality of channels, simultaneous multichannel measurement of light can be accomplished without the use of a beam selector.

1. A multipoint measurement system comprising: a light source; a plurality of illuminating fibers for transmitting light from the light source to a sample so as to illuminate a plurality of points of the sample; a plurality of receiving fibers for collecting light beams including transmitted, reflected, scattered light beams at the plurality of points; an optical path selecting member for transmitting a light beam collected by one of the plurality of receiving fibers through the receiving fiber; and an optical measuring instrument.

2. The multipoint measurement system according to claim 1, wherein the plurality of receiving fibers are divided into first receiving fibers and second receiving fibers and arranged along a circumference, and the optical path selecting member comprises a rotatable disk which has an aperture for passing light and is provided between the first receiving fibers and second receiving fibers.

3. The multipoint measurement system according to claim 1, wherein the plurality of receiving fibers are divided into first receiving fibers and second receiving fibers, and the optical path selecting member comprises a drivable shutter provided between the first receiving fibers and second receiving fibers.

4. A multipoint measurement method for performing optical measurements by transmitting light of a light source through a plurality of illuminating fibers to a sample so as to illuminate a plurality of points of the sample, collecting light of the light source and light beams including transmitted, reflected, scattered light beams at the plurality of points by a plurality of receiving fibers, and supplying the collected light beams to an optical measuring instrument, the multipoint measurement method comprising the steps of:
a process for performing a base measurement for measuring light that is transmitted through the illuminating fibers and receiving fibers in a condition where there is no influence of a sample and performing a first monitoring of light of the light source;
a process for performing a sample measurement carried out with a sample being placed for measuring light transmitted through the illuminating fibers, the sample, and the receiving fibers and performing a second monitoring of light of the light source;
a process for obtaining an optical measurement value of the sample by dividing the quotient of an optical intensity obtained from the sample measurement with the sample being placed/an optical intensity of the light source obtained from the second monitoring by the quotient of an optical intensity obtained from the base measurement with no influence of a sample/an optical intensity of the light source obtained from the first monitoring; and
a process for outputting the obtained optical measurement value of the sample.

5. A multipoint measurement method using a multipoint measurement system comprising a light source, a plurality of illuminating fibers for transmitting light from the light source to a sample so as to illuminate a plurality of points of the sample, a plurality of receiving fibers for collecting light beams including transmitted, reflected, scattered light beams at the plurality of points, an optical path selecting member for transmitting a light beam collected by one of the plurality of receiving fibers through the receiving fiber, and an optical measuring instrument, the multipoint measurement method comprising the steps of:
a process for performing a base measurement for measuring light that is transmitted through the illuminating fibers and receiving fibers in a condition where there is no influence of a sample and performing a first monitoring of light of the light source;
a process for performing a sample measurement carried out with a sample being placed for measuring light transmitted through the illuminating fibers, the sample, and the receiving fibers and performing a second monitoring of light of the light source;
a process for obtaining an optical measurement value of the sample by dividing the quotient of an optical intensity obtained from the sample measurement with the sample being placed/an optical intensity of the light source obtained from the second monitoring by the quotient of
an optical intensity obtained from the base measurement with no influence of a sample/an optical intensity of the light source obtained from the first monitoring; and
a process for outputting the obtained optical measurement value of the sample.
